(19) United States
(12) Patent Application Publication
(10) Pub. No.: US 2023/0133765 A1
(43) Pub. Date: May 4, 2023

(54) ENGINE CONTROLLER AND ENGINE CONTROLLING METHOD

(71) Applicant: TOYOTA JIDOSHA KABUSHIKI KAISHA, Aichi-ken (JP)

(72) Inventors: Hiroaki MIZOGUCHI, Nagoya-shi (JP); Machiko TAKAHASHI, Toyota-shi (JP); Nobuo YAGIHASHI, Miyoshi-shi (JP)

(21) Appl. No.: 17/970,568

(22) Filed: Oct. 21, 2022

(30) Foreign Application Priority Data
Oct. 29, 2021 (JP) 2021-177608

(51) Int. Cl. F02B 39/00; F02B 37/12

(52) U.S. Cl. CPC F02B 39/005; F02B 37/12

(57) ABSTRACT

An engine controller is configured to control an engine that includes a turbocharger and an electric pump that supplies a cooling water to the turbocharger. The engine controller includes a processor. The processor is configured to vary a flow rate of the cooling water supplied to the turbocharger by the electric pump during operation of the engine, based on a housing temperature, which is a temperature of a turbine housing of the turbocharger, and a generation site temperature, which is a temperature of a generation site of oil coke inside the turbocharger.

### BACKGROUND

### 1. Field

The present disclosure relates to an engine controller and an engine controlling method that control an engine equipped with a turbocharger.

### 2. Description of Related Art

In an engine equipped with a turbocharger and a blow-by gas reducing device, blow-by gas flows into the compressor of the turbocharger together with intake air. Oil mist in the blow-by gas may be carbonized and accumulated on the compressor. Japanese Laid-Open Patent Publication No. 2020-128724 discloses a technique that supplies cooling water to a turbocharger when the temperature of intake air flowing out of a compressor is higher than or equal to a certain value of the temperature, thereby reducing carbonization and accumulation of oil mist.

A turbocharger contains oil used, for example, to lubricate journals. When the engine is operating, exhaust gas heats the turbocharger so that its internal temperature increases. This carbonizes oil in the turbocharger and the carbonized oil is accumulated, for example, on the wall surfaces of the oil passage and components such as the journals. An increased accumulation of carbonized oil, which is referred to as oil coke, can hinder flow of oil or rotation of the turbine shaft. Accordingly, there is a demand for reduction in accumulation of oil coke in turbochargers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an engine controller configured to control an engine is provided. The engine includes a turbocharger and an electric pump that supplies a cooling water to the turbocharger. The engine controller includes circuitry. The circuitry is configured to vary a flow rate of the cooling water supplied to the turbocharger by the electric pump during operation of the engine, based on a housing temperature, which is a temperature of a turbine housing of the turbocharger, and a generation site temperature, which is a temperature of a generation site of oil coke inside the turbocharger.

In the above-described engine controller, the processing device sets the flow rate of the cooling water supplied to the turbocharger by the electric pump during operation of the engine based on the temperature of the turbine housing and the temperature of the generation site of oil coke. This allows the flow rate of the cooling water to be set appropriately taking into consideration a future temperature increase of the generation site due to heat transfer from the turbine housing. Accordingly, the formation and accumulation of oil coke are reduced effectively.

In the above-described engine controller, the circuitry is configured to: execute a post-stoppage cooling control by driving the electric pump after the engine is stopped, the post-stoppage cooling control supplying the cooling water to the turbocharger; and vary driving time of the electric pump in the post-stoppage cooling control, based on an engine-stoppage housing temperature, which is the housing temperature when the engine is stopped, and an engine-stoppage generation site temperature, which is the generation site temperature when the engine is stopped. This configuration allows the driving time of the electric pump after stoppage of the engine to be set appropriately taking into consideration heat transfer from the turbine housing after the stoppage of the engine to the generation site. The circuitry may be configured to vary the flow rate of the cooling water supplied to the turbocharger in the post-stoppage cooling control, based on the engine-stoppage housing temperature and the engine-stoppage generation site temperature.

In another general aspect, an engine controlling method of controlling an engine is provided. The engine includes a turbocharger and an electric pump that supplies a cooling water to the turbocharger. The engine controlling method includes varying a flow rate of the cooling water supplied to the turbocharger by the electric pump during operation of the engine, based on a housing temperature, which is a temperature of a turbine housing of the turbocharger, and a generation site temperature, which is a temperature of a generation site of oil coke inside the turbocharger.

Other features and aspects will be apparent from the following detailed description, the drawings, and the claims.

### BRIEF DESCRIPTION OF THE DRAWINGS

FIG. 1 is a schematic diagram showing an engine controller according to one embodiment.

FIG. 2 is a flowchart of a mid-operation cooling control routine executed by the engine controller.

FIG. 3 is a flowchart of a post-stoppage cooling control routine executed by the engine controller.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

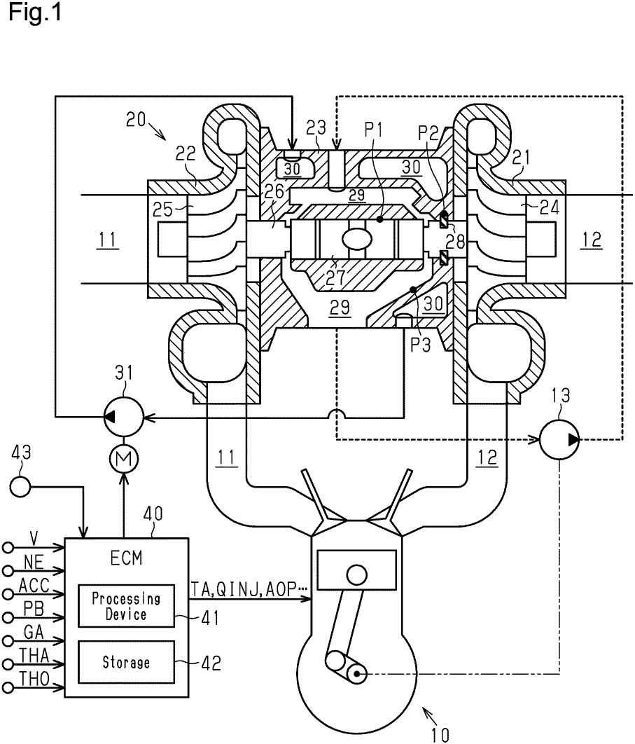

An engine controller according to one embodiment will be described with reference to FIGS. 1 to 3. The engine controller according to the present embodiment is employed in an engine 10 mounted on a vehicle.

### Configuration of Engine Controller

First, the configuration of the engine controller according to the present embodiment will be described with reference to FIG. 1. As shown in FIG. 1, the engine 10 is provided with an intake passage 11 and an exhaust passage 12. The engine 10 is also provided with an oil pump 13, which is driven by rotation of the engine 10.

The engine 10 is provided with a turbocharger 20. The turbocharger 20 includes a turbine housing 21, which is provided on the exhaust passage 12 of the engine 10, and a compressor housing 22, which is provided on the intake passage 11 of the engine 10. The turbine housing 21 and the compressor housing 22 are coupled to each other by a journal housing 23. The turbine housing 21 incorporates a turbine wheel 24, which is rotated by receiving flow of exhaust gas flowing through the exhaust passage 12. The compressor housing 22 incorporates a compressor wheel 25, which rotates to compress intake air flowing through the intake passage 11. The journal housing 23 receives a turbine shaft 26, which couples the turbine wheel 24 and the compressor wheel 25 to each other. The turbine shaft 26 is supported by a floating bearing 27 so as to be rotatable with respect to the journal housing 23. A seal ring 28 is attached to a section of the turbine shaft 26 that is close to the section coupled to the turbine wheel 24 to restrict inflow of exhaust gas from the turbine housing 21 into the journal housing 23.

An oil passage 29 is formed in the journal housing 23 to cause oil to flow through the floating bearing 27. The oil passage 29 is supplied with some of the oil discharged by the oil pump 13. Also, a water jacket 30 is formed in the journal housing 23. The water jacket 30 is a passage through which cooling water flows. The water jacket 30 is supplied with cooling water by an electric pump 31, which is located outside the turbocharger 20.

The vehicle in which the engine 10 is mounted is equipped with an engine control module (ECM) 40. The ECM 40 includes a processing device 41, which executes various types of processes to control the engine, and a storage 42, which stores programs and data for controlling the engine. The ECM 40 receives detection signals of state quantities indicating the traveling state of the vehicle, such as a vehicle speed V, an engine rotation speed NE, an accelerator pedal depression amount ACC, a boost pressure PB, an intake air flow rate GA, an intake air temperature THA, and an outside air temperature THO. The ECM 40 also receives an IG signal, which indicates an operating state of an ignition switch 43. Based on the received signals, the ECM 40 controls, for example, a throttle opening degree TA, a fuel injection amount QINJ, an ignition timing AOP of the engine 10.

During the operation of the engine 10, the ECM 40 estimates a housing temperature TH1, which is the temperature of the turbine housing 21, and temperatures of generation sites P1 to P3 of oil coke. The generation site P1 is a section in the oil passage 29 that is close to the seal ring 28. The generation site P2 is a section in the oil passage 29 that is close to the floating bearing 27. The generation site P3 is an oil drain portion, which is a section of the oil passage 29 that is on the downstream side of the floating bearing 27. In the following description, the temperature of the generation site P1 will be referred to as a seal ring temperature TH2, the temperature of the generation site P2 will be referred to as a bearing temperature TH3, and the temperature of the generation site P3 will be referred to as an oil drain temperature TH4.

The ECM 40 estimates the housing temperature TH1, the seal ring temperature TH2, the bearing temperature TH3, and the oil drain temperature TH4 based on various state quantities that represent the traveling condition of the vehicle. The state quantities used to estimate the temperatures include the vehicle speed V, the engine rotation speed NE, the accelerator pedal depression amount ACC, the fuel injection amount QINJ, the boost pressure PB, the intake air flow rate GA, the intake air temperature THA, and the outside air temperature THO. The temperatures are estimated, for example, by a neural network that has been trained through machine learning.

### Mid-Operation Cooling Control

The ECM 40 performs a mid-operation cooling control to cool the turbocharger 20 during the operation of the engine 10. The mid-operation cooling control is performed to cool the turbocharger 20 by driving the electric pump 31 when the temperature of the turbocharger 20 is relatively high. The mid-operation cooling control determines whether to drive the electric pump 31 based on the housing temperature TH1, the seal ring temperature TH2, the bearing temperature TH3, and the oil drain temperature TH4. Also, the mid-operation cooling control determines the flow rate of cooling water supplied to the turbocharger 20 by the electric pump 31 based on the housing temperature TH1, the seal ring temperature TH2, the bearing temperature TH3, and the oil drain temperature TH4.

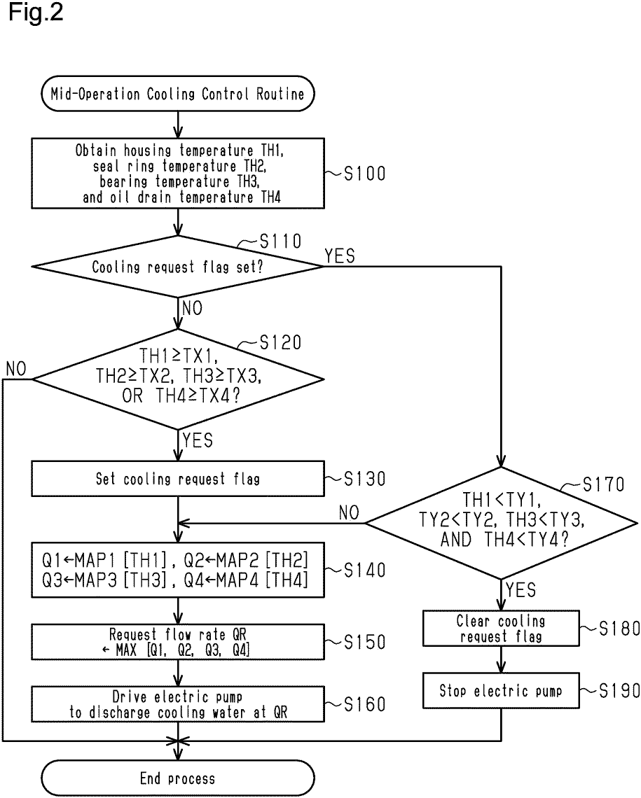

FIG. 2 shows a flowchart of a mid-operation cooling control routine. The ECM 40 performs the routine to implement the mid-operation cooling control. The ECM 40 repeatedly executes the routine at each predefined control cycle during the operation of the engine 10.

When starting this routine, the ECM 40 obtains, in step S100, values of the housing temperature TH1, the seal ring temperature TH2, the bearing temperature TH3, and the oil drain temperature TH4 that have been estimated in advance. Next, the ECM 40 determines whether a cooling request flag is set in step S110. The cooling request flag indicates whether a request to drive the electric pump 31 was made in the previous execution of this routine. If the cooling request flag is set (YES), the ECM 40 advances the process to step S120. If the cooling request flag is not set (NO), the ECM 40 advances the process to step S170.

A process that is executed when the cooling request flag is not set (S110: NO) will now be described. In this case, the ECM 40 determines, in step S120, whether the electric pump 31 needs to be driven based on the housing temperature TH1, the seal ring temperature TH2, the bearing temperature TH3, and the oil drain temperature TH4. Specifically, the ECM 40 determines whether the electric pump 31 needs to be driven depending on whether at least one of conditions (A) to (D) is met. Condition (A) is that the housing temperature TH1 is higher than or equal to a first high-temperature determination value TX1. Condition (B) is that the seal ring temperature TH2 is higher than or equal to a second high-temperature determination value TX2. Condition (C) is that the bearing temperature TH3 is higher than or equal to the third high-temperature determination value TX3. Condition (D) is that the oil drain temperature TH4 is higher than or equal to the fourth high-temperature determination value TX4. When determining that the electric pump 31 does not need to be driven (NO), the ECM 40 ends the current process of this routine. In contrast, when determining that the electric pump 31 needs to be driven, the ECM 40 advances the process to step S130. Then, the ECM 40 sets the cooling request flag in step S130.

Subsequently, the ECM 40 calculates first to fourth request flow rates Q1 to Q4 in step S140. The first request flow rate Q1 is calculated based on the housing temperature TH1 using a first calculation map MAP1. The first request flow rate Q1 represents a flow rate of the cooling water required to lower the housing temperature TH1 to an appropriate temperature. The first calculation map MAP1 is designed to increase the value of the first request flow rate Q1 as the housing temperature TH1 increases after exceeding a first low-temperature determination value TY1, which will be discussed below.

The second request flow rate Q2 is calculated based on the seal ring temperature TH2 using a second calculation map MAP2. The second request flow rate Q2 represents a flow rate of the cooling water required to lower the seal ring temperature TH2 to an appropriate temperature that reduces the formation of oil coke in the vicinity of the seal ring 28. The second calculation map MAP2 is designed to increase the value of the second request flow rate Q2 as the seal ring temperature TH2 increases after exceeding a second low-temperature determination value TY2, which will be discussed below. The third request flow rate Q3 is calculated based on the bearing temperature TH3 using a third calculation map MAP3. The third request flow rate Q3 represents a flow rate of the cooling water required to lower the bearing temperature TH3 to an appropriate temperature that reduces the formation of oil coke in the vicinity of the floating bearing 27. The third calculation map MAP3 is designed to increase the value of the third request flow rate Q3 as the bearing temperature TH3 increases after exceeding a third low-temperature determination value TY3, which will be discussed below. The fourth request flow rate Q4 is calculated based on the oil drain temperature TH4 using a fourth calculation map MAP4. The fourth request flow rate Q4 represents a flow rate of the cooling water required to lower the temperature of the oil drain portion of the oil passage 29 to an appropriate temperature that reduces the formation of oil coke. The fourth calculation map MAP4 is designed to increase the value of the fourth request flow rate Q4 as the oil drain temperature TH4 increases after exceeding a fourth low-temperature determination value TY4, which will be discussed below.

Then, in step S150, the ECM 40 sets the value of a request flow rate QR to the greatest value of the first to fourth request flow rates Q1 to Q4. Next, in step S160, the ECM 40 drives the electric pump 31 to discharge the cooling water at the request flow rate QR. Then, the ECM 40 ends the process of the current routine.

Next, a process that is executed when the cooling request flag is set (S110: YES) will be described. In this case, the electric pump 31 was being driven during the previous execution of this routine. In step S170, the ECM 40 determines whether the electric pump 31 needs to continue to be driven based on the housing temperature TH1, the seal ring temperature TH2, the bearing temperature TH3, and the oil drain temperature TH4. Specifically, the ECM 40 determines to stop the electric pump 31 when all of the following conditions (E) to (H) are met. If at least one of the conditions (E) to (H) is not met, the ECM 40 determines to continue to drive the electric pump 31. Condition (E) is that the housing temperature TH1 is lower than the first low-temperature determination value TY1. The first low-temperature determination value TY1 is set to a temperature that is lower than the first high-temperature determination value TX1. Condition (F) is that the seal ring temperature TH2 is lower than the second low-temperature determination value TY2. The second low-temperature determination value TY2 is set to a temperature that is lower than the second high-temperature determination value TX2. Condition (G) is that the bearing temperature TH3 is lower than the third low-temperature determination value TY3. The third low-temperature determination value TY3 is set to a temperature that is lower than the third high-temperature determination value TX3. Condition (H) is that the oil drain temperature TH4 is lower than the fourth low-temperature determination value TY4. The fourth low-temperature determination value TY4 is set to a temperature that is lower than the fourth high-temperature determination value TX4.

When determining to continue to drive the electric pump 31 (S170: NO), the ECM 40 advances the process to step S140. When determining to stop the electric pump 31 (S170: YES), the ECM 40 clears the cooling request flag in step S180. After stopping the electric pump 31 in step S190, the ECM 40 ends the current process of this routine.

### Post-Stoppage Cooling Control Routine

Further, if the temperature of the turbocharger 20 is relatively high when the engine 10 stops, the ECM 40 drives the electric pump 31 after the engine 10 stops, thereby cooling the turbocharger 20. A post-stoppage cooling control will now be described, which is related to driving of the electric pump 31 after the engine 10 stops.

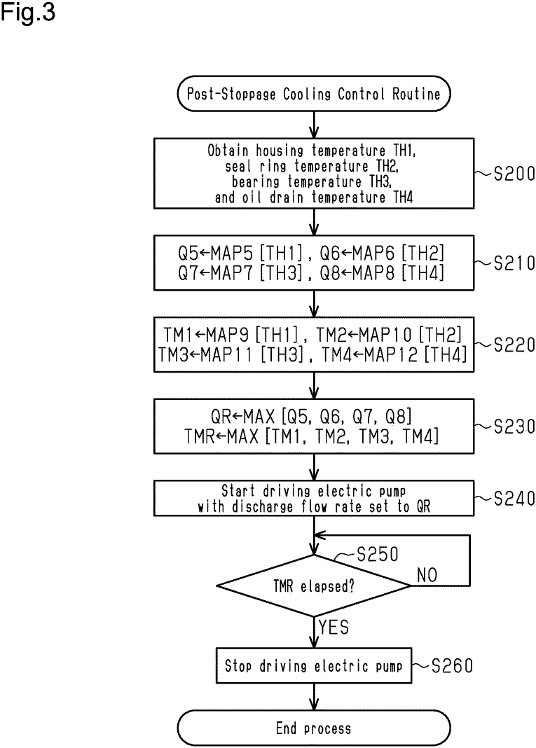

FIG. 3 shows a procedure performed by the ECM 40 in accordance with the post-stoppage cooling control. The ECM 40 starts the process shown in FIG. 3 in response to stoppage of the engine 10.

When the engine 10 stops, the ECM 40 first obtains, in step S200, the current values of the housing temperature TH1, the seal ring temperature TH2, the bearing temperature TH3, at the oil drain temperature TH4. The obtained value of the housing temperature TH1 corresponds to an engine-stoppage housing temperature. Also, the seal ring temperature TH2, the bearing temperature TH3, and the oil drain temperature TH4 that are obtained at this time correspond to engine-stoppage generation site temperatures.

Next, the ECM 40 calculates fifth to eighth request flow rates Q5 to Q8 in step S210. The fifth request flow rate Q5 is calculated based on the housing temperature TH1, which has been obtained in step S200, using a fifth calculation map MAP5. The fifth request flow rate Q5 represents a flow rate of the cooling water required to lower the housing temperature TH1 to an appropriate temperature. The sixth request flow rate Q6 is calculated based on the seal ring temperature TH2, which has been obtained in step S200, using a sixth calculation map MAP6. The sixth request flow rate Q6 represents a flow rate of the cooling water required to lower the seal ring temperature TH2 to an appropriate temperature that reduces the formation of oil coke. The seventh request flow rate Q7 is calculated based on the bearing temperature TH3, which has been obtained in step S200, using a seventh calculation map MAP7. The seventh request flow rate Q7 represents a flow rate of the cooling water required to lower the bearing temperature TH3 to an appropriate temperature that reduces the formation of oil coke. The eighth request flow rate Q8 is calculated based on the oil drain temperature TH4, which has been obtained in step S200, using an eighth calculation map MAP8. The eighth request flow rate Q8 represents a flow rate of the cooling water required to lower the oil drain temperature TH4 to an appropriate temperature that reduces the formation of oil coke. The fifth to eighth calculation maps MAP5 to MAP8 are each designed to set the value of the request flow rate to 0 when the temperature of the corresponding site is lower than a certain value of the temperature. Also, the fifth to eighth calculation maps MAP5 to MAP8 are each designed to increase the value of the request flow rate as the temperature at the corresponding site increases, when the temperature at the corresponding site is higher than or equal to the certain value of the temperature. The certain value is different for each of the fifth to eighth calculation maps MAP5 to MAP8.

Subsequently, the ECM 40 calculates a first request driving time TM1, a second request driving time TM2, a third request driving time TM3, and a fourth request driving time TM4 in step S220. The first request driving time TM1 is calculated based on the housing temperature TH1, which has been obtained in step S200, using a ninth calculation map MAP9. The first request driving time TM1 represents driving time of the electric pump 31 required to lower the housing temperature TH1 to an appropriate temperature. The ninth calculation map MAP9 is designed to set the value of the first request driving time TM1 to 0 when the housing temperature TH1 is lower than a certain value of the temperature. The ninth calculation map MAP9 is designed to increase the value of the first request driving time TM1 as the housing temperature TH1 increases when the housing temperature TH1 is higher than or equal to the certain value. The second request driving time TM2 is calculated based on the seal ring temperature TH2, which has been obtained in step S200, using a tenth calculation map MAP10. The second request driving time TM2 represents driving time of the electric pump 31 required to lower the seal ring temperature TH2 to an appropriate temperature that reduces the formation of oil coke. The third request driving time TM3 is calculated based on the bearing temperature TH3, which has been obtained in step S200, using an eleventh calculation map MAP11. The third request driving time TM3 represents driving time of the electric pump 31 required to lower the bearing temperature TH3 to an appropriate temperature that reduces the formation of oil coke. The fourth request driving time TM4 is calculated based on the oil drain temperature TH4, which has been obtained in step S200, using a twelfth calculation map MAP12. The fourth request driving time TM4 represents driving time of the electric pump 31 required to lower the oil drain temperature TH4 to an appropriate temperature that reduces the formation of oil coke. The ninth to twelfth calculation maps MAP9 to MAP12 are each designed to set the value of the request driving time to 0 when the temperature of the corresponding site is lower than a certain value of the temperature. Also, the ninth to twelfth calculation maps MAP9 to MAP12 are each designed to increase the value of the request driving time as the temperature of the site increases, when the temperature of the corresponding site is higher than or equal to the certain value of the temperature. The certain value is different for each of the ninth to twelfth calculation maps MAP9 to MAP12.

Next, in step S230, the ECM 40 sets the value of the request flow rate QR to the greatest value of the fifth to eighth request flow rates Q5 to Q8. Also, in step S230, the ECM 40 sets the value of a request driving time TMR to the greatest value of the first to fourth request driving times TM1 to TM4.

Then, in step S240, the ECM 40 starts driving the electric pump 31 while setting the discharge flow rate to the request flow rate QR. Thereafter, in step S250, the ECM 40 waits until a time period corresponding to the value of the request driving time TMR has elapsed. When the time period corresponding to the value of the request driving time TMR has elapsed (S250: YES), the ECM 40 advances the process to step S260. In a case in which the value of the request driving time TMR has been set to 0, the ECM 40 advances the process to step S260 without driving the electric pump 31. In step S260, the ECM 40 stops the electric pump 31. The ECM 40 thus ends the post-stoppage cooling control.

### Operation and Advantages of Embodiment

Operation and advantages of the present embodiment will now be described.

High-temperature exhaust gas flows into the turbine housing 21 during the operation of the engine 10. The heat of the exhaust gas is transferred to the turbine housing 21. The heat transfer from the turbine housing 21 increases the temperatures of the generation sites P1 to P3 of oil coke inside the turbocharger 20. If the temperatures of the generation sites P1 to P3 continue to be higher than a certain value of the temperature, oil coke will be generated and accumulated.

The mid-operation cooling control drives the electric pump 31 when the temperature of the turbocharger 20 is relatively high. Accordingly, the cooling water is supplied to the water jacket 30 of the turbocharger 20 to cool the generation sites P1 to P3. This reduces the formation and accumulation of oil coke at the generation sites P1 to P3.

Even in a case in which the temperatures of the generation sites P1 to P3 are not significantly high, if the housing temperature TH1 is relatively high, heat transfer from the turbine housing 21 can eventually increase the temperatures of the generation sites P1 to P3. In the present embodiment, the flow rate of the cooling water supplied to the turbocharger 20 is varied depending on the temperatures of the generation sites P1 to P3 and the temperature of the turbine housing 21. This allows the flow rate of the cooling water to be set appropriately taking into consideration a future temperature increase of the generation sites P1 to P3 due to heat transfer from the turbine housing 21.

Also, in the present embodiment, if the temperature of the turbocharger 20 is relatively high when the engine 10 is stopped, the post-stoppage cooling control is performed to drive the electric pump 31 after the engine 10 is stopped. In a case in which the engine 10 is stopped and the temperatures of the generation sites P1 to P3 are not significantly high, heat transfer from the turbine housing 21 can subsequently increase the temperatures of the generation sites P1 to P3 if the housing temperature TH1 is relatively high. In the post-stoppage cooling control according to the present embodiment, the flow rate of the cooling water supplied to the turbocharger 20 and the driving time of the electric pump 31 are varied depending on the temperatures of the generation sites P1 to P3 and the temperature of the turbine housing 21. This allows the flow rate of the cooling water and the driving time to be set appropriately taking into consideration a future temperature increase of the generation sites P1 to P3 due to the heat transfer from the turbine housing 21.

The housing temperature TH1, the seal ring temperature TH2, the bearing temperature TH3, and the oil drain temperature TH4 are estimated during the operation of the engine 10. This allows the flow rate of the cooling water to be adjusted constantly in accordance with changes in the temperatures in the mid-operation cooling control. In contrast, after the engine 10 is stopped, the temperatures are not estimated, and the flow rate of the cooling water must be determined based only on the temperatures at the time of stoppage of the engine 10. Also, after the engine 10 is stopped, the turbine housing 21 stops being heated by the exhaust gas. Further, after the engine 10 is stopped, the oil pump 13 is stopped, so that the flow of oil through the oil passage 29 stagnates. In this manner, the conditions after the stoppage of the engine 10 are significantly different from those during the operation of the engine 10. Therefore, the post-stoppage cooling control uses calculation maps different from those used in the mid-operation cooling control in order to calculate the request flow rates.

The engine controller of the present embodiment has the following advantages.
(1) The flow rate of the cooling water supplied to the turbocharger 20 by the electric pump 31 during the operation of the engine 10 is varied based on the respective temperatures of the turbine housing 21 and the generation sites P1 to P3 of oil coke. Accordingly, the cooling water of an appropriate flow rate is supplied to the turbocharger 20, so as to reduce the formation and accumulation of oil coke effectively.
(2) The electric pump 31 is driven to supply an appropriate amount of the cooling water. This reduces the power consumption and the operating noise of the electric pump 31.
(3) The driving time of the electric pump 31 after the engine 10 is stopped is varied based on the housing temperature TH1 and the temperatures of the generation sites P1 to P3 at the time of stoppage of the engine 10. This sets the driving time of the electric pump 31 after the stoppage of the engine 10 to time appropriate for reducing oil coke.
(4) The flow rate of the cooling water supplied to the turbocharger 20 by the electric pump 31 after the engine 10 is stopped is varied based on the housing temperature TH1 and the respective temperatures of the generation sites P1 to P3 at the time of stoppage of the engine 10. This sets the flow rate of the cooling water supplied by the electric pump 31 after the engine 10 is stopped to time appropriate for reducing oil coke.

The above-described embodiment may be modified as follows. The above-described embodiment and the following modifications can be combined as long as the combined modifications remain technically consistent with each other.

In the above-described embodiment, the request flow rate QR in the post-stoppage cooling control is varied in accordance with the temperatures (TH1 to TH4). However, the request flow rate QR may be a fixed value. The request driving time TMR for the electric pump 31 and the request flow rate QR in the post-stoppage cooling control may be fixed values irrespective of the temperatures (TH1 to TH4).

Only the mid-operation cooling control, of the mid-operation cooling control and post-stoppage cooling control, may be performed.

In the above-described embodiment, the housing temperature TH1, the seal ring temperature TH2, the bearing temperature TH3, and the oil drain temperature TH4 are estimated based on the traveling condition of the vehicle. One or all of these temperatures may be measured by temperature sensors.

The positions of sites where oil coke is generated and the number of such sites vary depending on the structure of the turbocharger. Therefore, the positions and number of sites the temperatures of which are used to calculate the request flow rate QR and the request driving time TMR may be changed in accordance with the structure of the turbocharger.

The ECM 40 or the processing device 41 may include one or more processors that perform various processes according to computer programs (software). The ECM 40 or the processing device 41 may be circuitry including one or more dedicated hardware circuits such as application specific integrated circuits (ASICs) that execute at least part of various processes, or a combination thereof. The processor includes a CPU and a memory such as a RAM and a ROM. The memory stores program code or instructions configured to cause the CPU to execute processes. The memory, which is a computer-readable medium, includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine controller configured to control an engine, the engine including a turbocharger and an electric pump that supplies a cooling water to the turbocharger, the engine controller comprising:
a processor that is configured to vary a flow rate of the cooling water supplied to the turbocharger by the electric pump during operation of the engine, based on a housing temperature, which is a temperature of a turbine housing of the turbocharger, and a generation site temperature, which is a temperature of a generation site of oil coke inside the turbocharger.

2. The engine controller according to claim 1, wherein the processor is configured to
execute a post-stoppage cooling control by driving the electric pump after the engine is stopped, the post-stoppage cooling control supplying the cooling water to the turbocharger, and
vary driving time of the electric pump in the post-stoppage cooling control, based on an engine-stoppage housing temperature, which is the housing temperature when the engine is stopped, and an engine-stoppage generation site temperature, which is the generation site temperature when the engine is stopped.

3. The engine controller according to claim 2, wherein the processor is configured to vary the flow rate of the cooling water supplied to the turbocharger in the post-stoppage cooling control, based on the engine-stoppage housing temperature and the engine-stoppage generation site temperature.

4. An engine controlling method of controlling an engine, the engine including a turbocharger and an electric pump that supplies a cooling water to the turbocharger, the engine controlling method comprising:
varying a flow rate of the cooling water supplied to the turbocharger by the electric pump during operation of the engine, based on a housing temperature, which is a temperature of a turbine housing of the turbocharger, and a generation site temperature, which is a temperature of a generation site of oil coke inside the turbocharger.
